(19) United States
(12) Patent Application Publication
(10) Pub. No.: US 2022/0133580 A1
(43) Pub. Date: May 5, 2022

(54) AN EYE GUIDE

(71) Applicants: Sandra MCDONOUGH, Long Sutton Lincolnshire (GB); MYRTLE TREE INNOVATIONS LTD, Spalding (GB)

(72) Inventor: Sandra McDONOUGH, Long Sutton (GB)

(21) Appl. No.: 17/428,949

(22) PCT Filed: Feb. 5, 2020
(86) PCT No.: PCT/IB20/50919

§ 371 Date: Aug. 5, 2021

(30) Foreign Application Priority Data
Feb. 6, 2019 (GB) 1901631.0
Oct. 4, 2019 (GB) 1914349.4

(51) Int. Cl. A61H 3/06

(52) U.S. Cl. CPC A61H 3/061; A61H 2201/165; A61H 2201/0157; A61H 2201/1607

(57) ABSTRACT

The present invention relates to an eye guide. The eye guide has an attachment means for locating the eye guide on a wearer and an elongate marker arranged to extend from the attachment means so as to be visible in peripheral field view by the wearer.

### FIELD OF INVENTION

The present invention relates to an eye guide. More particularly, but not exclusively, the present invention helps to reduce or prevent tremors, improves a wearer's gait and their eye alignment.

### BACKGROUND

Many people suffer from diseases or impediments that affect speech, gait, vision or which cause involuntary movements such as tremors.

Often these conditions are treated with medication that has limited effect or may only be effective for a limited period of time.

In some cases a device may be used by an affected person to help reduce or remove the aforementioned physical symptoms. However, such devices may be bulky, uncomfortable or impractical for regular use.

An aim of the present invention is to provide an improved eye guide that assists in overcoming the aforementioned physical symptoms.

### PRIOR ART

JP 2011 084831 (MASAO) discloses a cap with a visor, the visor having a sight line.

US 623 187 (MUNOZ) discloses an apparatus of diagnosing and treating neurological disorders.

US 2003/0072466 (EISENBRAUN) discloses a communication headset.

US 2004/0137969 (NASSIMI) discloses a voice activated wireless telephone headset.

WO 2002/25906 (WILTON et al) discloses a headset with a speaker.

WO 2006/111735 (CURTIS) discloses a device for improving the gait of an impaired patient.

### SUMMARY OF INVENTION

According to a first aspect of the present invention there is provided an eye guide for wearing on an ear comprising: eye guide for wearing on an ear comprising: an attachment means for locating the eye guide about the ear of a wearer; and an elongate marker arranged to extend from the attachment means so as to be visible in a peripheral field of view by the wearer, wherein the attachment means wraps by arching around at least an upper region of the outer ear where the wearer's ear attaches to their head, and the elongate marker extends from a forward facing region of the attachment means towards a region defined above an ear lobule and below an uppermost point of an ear helix.

The presence of the elongate marker within the peripheral vision of a wearer has been found to reduce or prevent tremors.

The presence of the elongate marker within the peripheral vision of a wearer has also been found to improve an uneven gait in a person with a gait impairment, such as gait affected by hemi spatial neglect

The presence of the elongate marker within the peripheral vision of a wearer has also been found to improve speech impediments.

The presence of the elongate marker within the peripheral vision of a wearer has been found to improve posture.

The presence of the elongate marker within the peripheral vision of a wearer has also been found to reduce pain.

The presence of the elongate marker within the peripheral vision of a wearer has been found to improve the sight of the wearer and assist in eye alignment and promote general wellbeing.

The eye guide is worn around the ear and the elongate marker extends close to the face in a region near to a lateral corner of the eye closest to the ear on which the guide is worn. The presence of the attachment means about the ear and the elongate marker in a field of peripheral vision have been shown to improve the aforementioned physical; symptoms which are often associated with certain neurological disorders, including for example Parkinson's disease.

The attachment means wraps around at least an upper part of the ear in order to locate and retain the eye guide on the wearer. In a preferred embodiment the attachment means wraps around the ear where the ear attaches to the wearer's head so as to be retained thereon. An elasticated means may be used to retain the attachment means. Optionally the elasticated means is adjustable in order to wrap the eye guide around the ear with sufficient tension.

Preferably the attachment means is flexible so that they can easily conform and fit snugly around the wearer's ear.

Ideally the attachment means is also deformable so that the attachment means can be shaped to correspond to the individual wearer's ear shape and size.

In preferred embodiments the attachment means has a soft outer layer. Alternatively, or in addition, it may be formed from a soft material so as to be comfortable against the wearer's ear. For example the attachment means may be formed in part or fully from a cellular deformable material, such as synthetic foam rubbers, such as elastomers.

In some embodiments the attachment means includes a deformable core, for example having a deformable metal wire embedded in its core, for at least part of the length of the attachment means. This enables a wearer or someone who is fitting the eye guide, to bend and shape the attachment means in a selective way to suit the size and shape of the ear of the wearer.

In some embodiments the attachment means may be manufactured in a specific shape and particular size for a specific user. For example the wearer's ear may be photographed or scanned and an attachment means may be 3-dimensionally printed or moulded to have a contact surface that corresponds to the wearer's ear shape.

In yet a further embodiment the attachment means may be supplied as a range of different size and shape rigid device which are connected to, and removable from, an end of the attachment means.

Preferably all edges of the attachment means are rounded and smooth so that nothing sharp protrudes and that no sharp scorners are presented to a wearer's ear.

In some embodiments the attachment means may include a slot for receiving the arms of a pair of spectacles. In this way the eye guide and spectacles can be worn comfortably at the same time.

In yet a further embodiment the attachment means is adapted to receive, attach to or fit about an externally fitted hearing aid that wraps around part of the ear. For example the attachment means may be shaped to fit about a hearing aid, having a substantially rigid part on a forward part of the ear that supports the elongate marker and an elastic portion that forms a loop that is attached to a rigid part of the attachment means. In this way the elastic loop can sit under, over, or alongside the hearing aid. Advantageously this modified version of the attachment means enables a wearer to wear an eye guide and their own hearing aid at the same time.

The attachment means of the eye guide is modified so that the attachment means, together with the external hearing aid, arch around and contact part of the outer circumference of the ear where it attaches to the head.

In this alternative embodiment the elastic loop acts as the attachment means and fits comfortably around the ear whilst accommodating a hearing aid and can be easily fitted to different shaped and sized ears.

It is appreciated that the substantially rigid forward part of the attachment means may be shaped and dimensioned to correspond to the shape of the hearing aid so that it forms a continuous smooth surface against the ear. For example the attachment means may be curved to receive a curved end of a hearing aid. Furthermore by having a flexible, elastic loop the loop can be easily positioned to fit adjacent the hearing aid.

Research has revealed that benefits are achieved when a portion of the attachment means extends around, and is in contact with, at least part of the upper ear. Therefore combining a standard external hearing aid with the attachment means of the eye guide meets this requirement.

In yet a further embodiment the attachment means of the eye guide may be adapted to include a hearing aid. In this way the eye guide may additionally assist with hearing. For example the attachment means may include components of the hearing aid and assist in amplifying sounds for the wearer.

The elongate marker projects from a forward facing region of the attachment means between the ear lobule and uppermost point of the helix. Preferably the elongate marker extends from a forward facing region of the attachment means in a region defined above the ear tragus and below an uppermost point of the ear helix. In this way the elongate marker extends forward around an eye level of the wearer.

Preferably the elongate marker is a separate integer that is received by and connects to the attachment means. For example the attachment means may have an aperture or hole for receiving a proximal end of the elongate marker. The hole may pass through the attachment means or be a blind hole. The hole may be adapted to receive the elongate marker. For example the hole and proximal end of the elongate marker may be shaped to mate or interlock to form a secure connection by way of inter-engaging portions. The connection may be permanent or semi-permanent to permit removal/exchange of the elongate marker.

Preferably the hole may be positioned centrally at a thicker portion of the attachment means or towards an outer side or face of the attachment means so as to space the elongate marker from a wearer's face. The hole is ideally at least 3 mm deep and preferably 5 mm deep.

A central location of the elongate marker also has the benefit of being suitable for a non-specific (left or right) handed eye guide.

In another embodiment the elongate marker may be integrated with the attachment means. In this way the eye guide may be formed as one single part.

In some embodiments the attachment means may include a securement means that locks the elongate marker to the attachment means in order to prevent dislodgment when worn.

The securement mechanism may also have an adjustment mechanism to permit adjustable movement of the elongate marker relative to the attachment mechanism. This mechanism may assist with correctly aligning the elongate marker on a wearer to ensure the distal end is located within the peripheral vision of the wearer.

In some embodiments the securement mechanism includes a catch to lock the elongate marker in place. In another embodiment the attachment means has a locking cam which clamps the marker in place once it has been cut to a required length and/or placed in position.

In another embodiment the securement mechanism has an extending mechanism supported on a concertina former. In this way the elongate marker is extendable or retractable by means of the concertina former.

In a further embodiment the securement mechanism is a rolling mechanism for rolling up part of the marker that is not required (in order to shorten the marker) thereby ensuring that any excess marker does not protrude and so is not problematic when extending beyond or from the attachment means.

The marker may be moved backwards and forwards with respect to the attachment means so as to fit the eye guide for a user. The elongate marker uses a securement mechanism to drive, regulate or lock the movement once the elongate maker is in the correction position.

In some embodiments the marker may have a serrated outer surface and may pass through corresponding teeth arranged within an aperture in the attachment means, to permit incremental adjustment of the position of the elongate marker.

Once the required length of the elongate marker has been determined, any excess may be cut, or stored, for example, by being rolled on a reel within the attachment means.

In yet a further embodiment the securement mechanism includes an elastomeric surface that is presented to the marker to grip onto or over it.

In some embodiments of the mechanism, the mechanism is temporary, for example so as to enable the marker part to be wholly removed from the eye guide. In this way it may be envisaged that the marker part may be single-use, cut to shape or bespoke. In other embodiments the marker part may be permanently attached to the attachment means.

In the embodiments shown in the Figures the marker part is able to be cut to length when in use and after securing in the mechanism at a base. The marker part may then be displaced from the mechanism and replaced in cases where the marker part has been cut too short.

The elongate marker is preferably a thin, lightweight device that extends close to the face of a user. The length of the elongate guide or marker is dependent upon the wearer as it is located away from a lateral corner of the wearer's eye in order to ensure that it is just visible in peripheral vision but does not interfere with the wearer's main field of vision.

For example the elongate marker may be formed from synthetic plastics or from metal.

Preferably the cross section of the elongate marker is substantially rectangular. In other embodiments the cross section of the elongate marker may be round, square or oval.

In some embodiments the distal end of the elongate marker may be shaped or coloured differently, for example to have a bulbous end or for the tip to be a different colour so that a distal end of the elongate marker is a more obvious target for the eye to view in peripheral vision. For example the elongate marker may be transparent apart from the distal end thereby being more discreet in use.

In some preferred embodiments the elongate marker is adjustable. For example the elongate marker may be suitable for being cut or may be adapted to be snapped at predefined increments so as to incrementally reduce the length of the eye guide.

It is appreciated that the eye guide is fitted specifically for user to ensure that the elongate marker is correctly positioned, and that the attachment means correctly fits about a wearer's ear.

Preferably the elongate marker extends horizontally from the attachment means.

In some embodiments the elongate marker tapers from one end to another. Preferably the elongate marker tapers from a proximal end to a distal end. This provides a sturdier connection to the attachment means whilst still being discreet in the eye region.

In another embodiment the elongate marker may taper from the distal end to the proximal end, so that the distal end is larger and therefore more prominent. This may be of benefit to a wearer requiring are larger target to detect in their peripheral vision.

In a preferred embodiment the elongate marker is white in colour. It is appreciated that the elongate marker may be provided in different colours to suit a user.

Research suggests that some colours may not have the same benefits as others, for example some colours may cause headaches for a wearer, therefore it is important the selected a colour that best suits the individual. As some colours may have different effects on the wearer, it is advisable to trial different colours on a wearer in order to ensure maximal beneficial effects are achieved.

In some preferred embodiments the elongate marker is transparent or translucent. In this way the elongate marker is discreet and has a less imposing effect on the peripheral vision of the wearer.

In some embodiments the elongate marker may also be deformable. In this way the elongate marker can be shaped to match the profile of a face and to position the distal end correctly within peripheral vision. For example the elongate marker may include or comprise a metal wire.

Research has indicated that the contact of the attachment means about the ear and the weight of the eye guide are important for gaining maximal benefits.

Preferably the eye guide weighs at least 5 grams. Eye guides of a lesser weight have been shown not to have the same benefits, especially with respect to improvements in gait and speech, in some users.

Typically the attachment means may be at least 4 grams and the elongate marker may be at least 1 gram to create a combined weight of at least 5 grams.

It is appreciated that the weight of the eye guide may be varied to suit a wearer. For example the weight may be increased or decreased to enhance benefits to an individual user.

The eye guide may be worn on either ear of a wearer. In some embodiments the eye guide may be left or right handed so that it is specifically shaped for use on either a left or right ear. Typically it may only be the attachment means that is left or right handed.

In another preferred embodiments the attachment means is symmetrical so as to be suitable for wearing on either ear.

It is appreciated that the eye guide may be made in different standard sizes such as small, medium and large, as well as made to order for a particular wearer.

Preferred embodiments of the invention will now be described, by way of examples only and with reference to the Figures in which:

### BRIEF DESCRIPTION OF FIGURES

FIG. 1 shows a side view of a first embodiment of an eye guide according to the present invention;

FIG. 2 shows a side view of a second embodiment of the eye guide according to the present invention;

FIG. 3 shows a side view of a third embodiment of the eye guide according to the present invention;

FIG. 4 shows a side diagrammatic view of a user attachment means for the eye guide according to the present invention;

FIG. 5 shows a side view, in detail, of a fourth embodiment of the eye guide according to the present invention;

FIG. 6 shows a side view, in detail, of a fifth embodiment of the eye guide according to the present invention; and

FIG. 7 shows a side view of an elongate marker; and

FIG. 8 shows a side view of a sixth embodiment of an eye guide

### DETAILED DESCRIPTION OF PREFERRED EMBODIMENTS

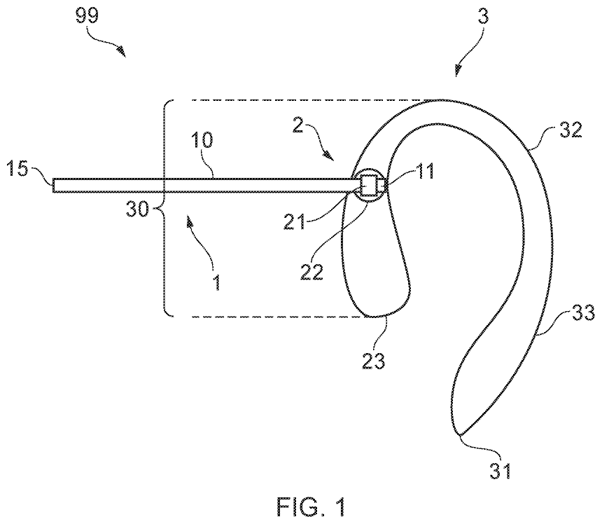

With reference to FIGS. 1, 2, 3, 5 and 6 there is generally shown an embodiment of the eye guide 99 worn over a wearer's ear (not shown). The eye guide 99 has an attachment means 3 arranged to locate the eye guide over a wearer's ear and an elongate marker 1 that extends from the attachment means so that a distal end of the elongate marker is visible in a wearer's peripheral vision.

The attachment means 3 curves around an upper region of the ear in a manner similar to some hearing aids known in the art.

The attachment means 3 has a forward region 30, indicated as the region between the dashed lines, an upper region 32 and a lower region 33 so as to wrap around part of the ear. The elongate marker 1 extends forwards from the attachment means 3 towards a wearer's eye so as to be located and appear in the peripheral vision of the user.

The attachment means 3 comprises a flared bottom end 31 which in use is located at a lower region of the rear of the ear near to the ear lobe.

An end of the attachment means that is located forward of the ear has a flared tab 23 which is held in front of the ear. In some embodiments the tab 23 may be transparent of translucent so as to be more discreet.

The tab 23 advantageously provides stability to the direction of the marker 1 in use. For example in some embodiments the tab 23 may be moveable with respect to the upper 32 and rear part 33 of the attachment means 3, for example being rotatable with reference to the attachment means 3, so as to rotate the base 2 from which the elongate marker extends.

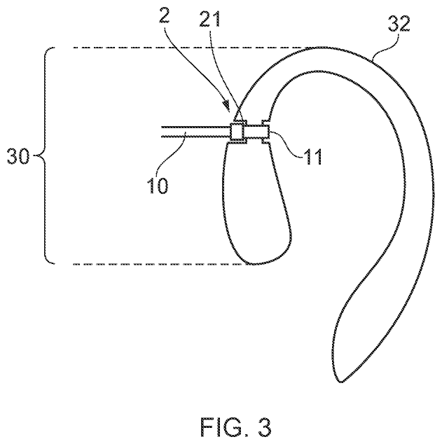

The base 2 may be inset into an indentation 22 in the tab 23 as shown in FIG. 1. The base 2 has a securement mechanism for the marker 1, and in some embodiments, this may include a catch 21 as shown in FIG. 1 or FIG. 3.

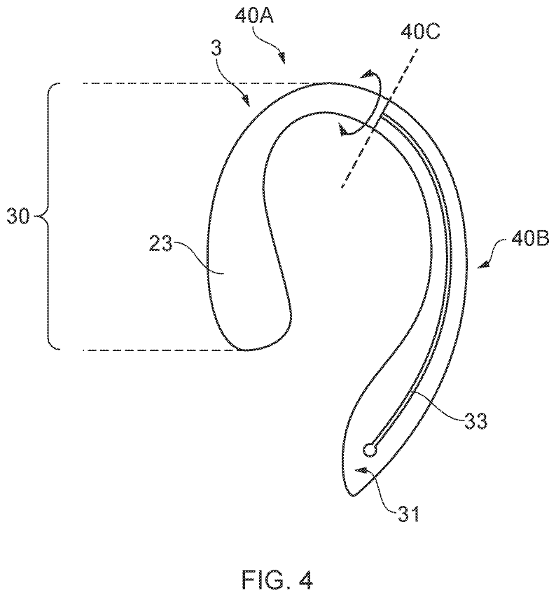

FIG. 4 shows the attachment means 3 without an elongate marker. Part of the marker 3 shows where the metal core 33 is positioned. The metal core 33 extends partially into the front region 30. The metal core 33 is malleable to allow the attachment means to be bent to match the shape of the wearer's ear.

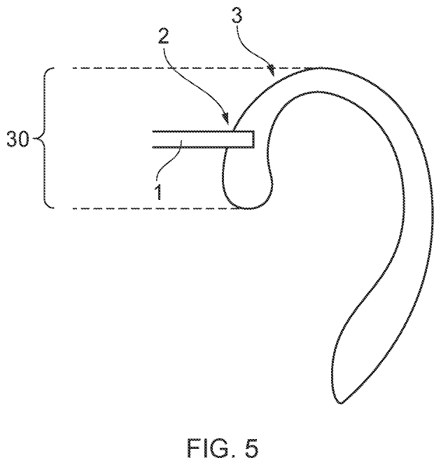

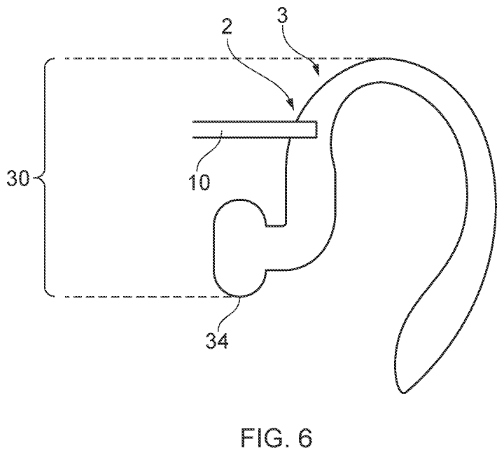

As shown in FIGS. 5 and 6 the marker 1 may be permanently joined at a permanent securement mechanism 2 to the attachment means 3.

In FIG. 6 the attachment means has an additional lobe 34 for helping to locate the attachment means on a wearer.

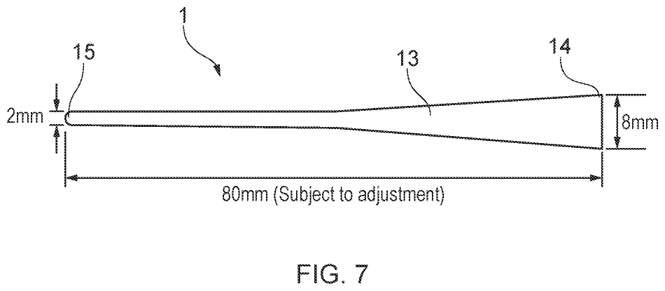

As shown in FIG. 7 the elongate mark 1 is tapered and has an enlarged stabilising tab 14 to provide further stability in use. The tab 14, tapers (see feature 13) to a distal end 15.

The marker 1 may be adjusted to account for dimensions of the user's face to ensure that the marker 1 is correctly located in use in the peripheral vision of the wearer.

In an alternative embodiment a resilient ratchet may be arranged to act as a detent against the serrated outer surface of the marker in order to allow a user to extend or retract the marker to a desired length and retain it in position.

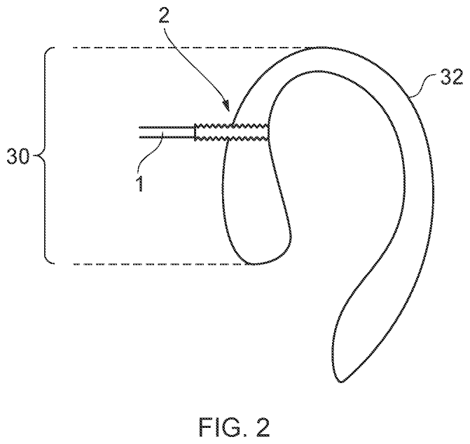

In FIG. 2 the base 2 has a concertina extending mechanism 2 that allows the position of the elongate marker 1 to be adjusted by pulling and thereby extending the concertina mechanism or pushing and thereby collapsing the concertina mechanism 2.

In the first and third embodiments (FIGS. 1 and 3) the eye guide comprises a catch 21 such that the proximal end of the marker 11 is passed through the catch 21 to the other side of the catch 21.

The marker part 1 may be arranged to be of a transparent or translucent material, which material thereby minimises distraction from the marker part, but allows it to be registered in the user's peripheral vision without significant interference with the user's eyesight.

The marker part is 1 provided in the pictured embodiments by an elongate, substantially rigid portion 10. This portion 10 may be flexible and/or deformable or it may be rigid.

In some embodiments, such as the one shown in FIG. 1 the base 2 rotates, and enables angling of the marker 1. For example in this way the marker 1 may be changed in orientation with respect to the attachment means and wearer's eyes, for example being tilted or inclined inwards to, or outwards from, a field of view.

Other embodiments may use the attachment means to change the orientation of the marker, such that the eye can be positioned to suit a wearer's preference.

In the pictured embodiments the attachment means 3 has a central wire core 33 that is over moulded with an outer layer. This provides comfort for the wearer, as well as permits the attachment means 3 to be effective in fitting about the wearer's ear. The attachment means has a fore part 40A and a rear part 40B which permit movement about the point of connection 40C. In this way the fore part 40A can be rotated (indicated by the arrow in FIG. 4) to adjust the angle at which the elongate marker extends and in order to alter fitting.

The over-moulding may be formed from a cellular material such as foam, synthetic plastics or rubber type material. For example, the outer layer may be formed from thermoplastic polyurethane (TPU) or medical grade silicone. Preferably the wire core wire 33 may be stainless steel or similar.

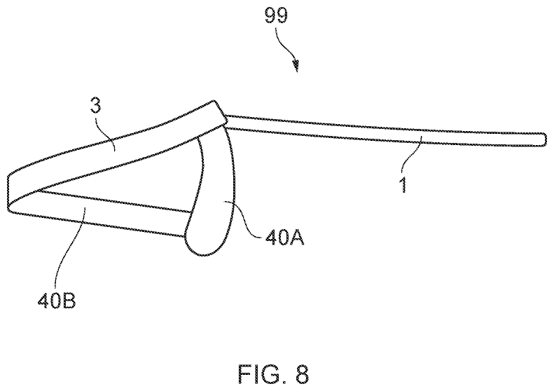

FIG. 8 shows an eye guide 99 with an attachment means 3 formed from two parts, a forward portion 40A and an elastic portion 40B.

The forward portion 40A is a rigid elongate part with a smooth outer surface. In use the forward portion 40A is arranged on a forward facing region of the ear. The elastic part 40B attaches at either end of the elongate part to form a loop. In this way the attachment means fits about the outer circumference of the outer ear so as to secure the eye guide on a user.

The elongate marker 1 projects from the forward part 40A. This allows the elongate marker to be securely mounted and directed forward towards the eye. The attachment means can be rotated about the ear to position the elongate marker in the correct orientation.

The invention has been described by way of examples only and it will be appreciated that variation may be made to the above-mentioned embodiments without departing from the scope of invention as defined by the claims.

1. An eye guide for wearing on an ear comprising:
an attachment means for locating the eye guide about the ear of a wearer; and
an elongate marker arranged to extend from the attachment means so as to be visible in a peripheral field of view by the wearer, wherein
the attachment means wraps by arching around at least an upper region of the outer ear where the wearer's ear attaches to their head, and
the elongate marker extends from a forward facing region of the attachment means towards a region defined above an ear lobule and below an uppermost point of an ear helix.

2. The eye guide for wearing on an ear according to claim 1 wherein
the elongate marker extends from a forward facing region of the attachment means in a region defined above the ear tragus and below an uppermost point of the ear helix.

3. The eye guide for wearing on an ear according to claim 1 wherein the elongate marker extends substantially horizontally.

4. The eye guide for wearing on an ear according to claim 1 wherein the attachment means is adapted to be attached to a wearer's hearing aid.

5. The eye guide for wearing on an ear according to claim 1 wherein at least part of the attachment means includes a deformable metal core.

6. The eye guide for wearing on an ear according to claim 1 wherein the attachment means includes an arcuate loop.

7. The eye guide for wearing on an ear according to claim 6 wherein at least part of the loop is elastic.

8. The eye guide for wearing on an ear according to claim 1 wherein the attachment means includes a base for receiving the elongate marker.

9. The eye guide for wearing on an ear according to claim 1 wherein the length of the elongate marker is adjustable.

10. The eye guide for wearing on an ear according to claim 1 further comprising a securement mechanism for connecting the elongate marker to the attachment means.

11. The eye guide for wearing on an ear according to claim 10 wherein the securement mechanism has an adjustment mechanism to permit adjustable movement of the elongate marker relative to the attachment mechanism.

12. The eye guide for wearing on an ear according to claim 10 wherein the securement mechanism includes a catch.

13. The eye guide for wearing on an ear according to claim 10, wherein the securement mechanism has a concertina extending mechanism.

14. The eye guide for wearing on an ear according to claim 10, wherein the securement mechanism has a resilient ratchet which engages with teeth or serrations in the elongate marker.

15. The eye guide for wearing on an ear according to claim 1 wherein the elongate marker tapers from a proximal end to a distal end.

16. The eye guide for wearing on an ear according to claim 1 wherein the elongate marker tapers from a distal end to a proximal end.

17. The eye guide for wearing on an ear according to claim 1 wherein the elongate marker is white in colour.

18. The eye guide for wearing on an ear according to claim 1 wherein the elongate marker is transparent or translucent.

19. The eye guide for wearing on an ear according to claim 1 wherein the elongate marker is permanently deformable to a user specified position.

20. The eye guide for wearing on an ear according to claim 1 weighing at least 5 grams.

21. The eye guide for wearing on an ear according to claim wherein an outer layer of the attachment means is resiliently deformable.

22. The eye guide for wearing on an ear according to claim 1 wherein the attachment means includes a hole through which the elongate marker passes.

23. The eye guide for wearing on an ear according to claim 22 wherein the hole is a blind hole for receiving the elongate marker.

24. The eye guide for wearing on an ear according to claim 1 wherein the attachment means is left handed or right handed.

25. The eye guide for wearing on an ear according to claim wherein the attachment means is symmetrical.
